(19) United States
(12) Patent Application Publication
(10) Pub. No.: US 2012/0092242 A1
(43) Pub. Date: Apr. 19, 2012

(54) DEVICE FOR PLACEMENT IN FRONT OF A DISPLAY DEVICE

(75) Inventors: Matthias Wendt, Wuerselen (DE); Helga Hummel, Aachen (DE); Wolfgang Otto Budde, Aachen (DE); Hans Peter Loebl, Monschau-imgenbroich (DE); Volker Weiler, Aachen (DE); Thomas Juestel, Witten (DE); Jacqueline Merikhi, Aachen (DE)

(73) Assignee: KONINKLIJKE PHILIPS ELECTRONICS N.V., EINDHOVEN (NL)

(21) Appl. No.: 13/259,661

(22) PCT Filed: Mar. 18, 2010
(86) PCT No.: PCT/IB2010/051172

§ 371 Date: Jan. 4, 2012

(30) Foreign Application Priority Data
Mar. 27, 2009 (EP) 09156471.6

(51) Int. Cl. G09G 3/36; G02F 1/13357

(52) U.S. Cl. 345/102; 349/62

(57) ABSTRACT

A system comprising a device for placement in front of a display device, such as a TV screen, to change the optical properties of light received by a user observing said display device, when the display device is in an off state or standby state, while when the display device is in an on state, the device appears transparent.

### FIELD OF THE INVENTION

This invention pertains in general to the field of displays. More particularly the invention relates to a device for placement in front of a display device configured to optically influence the properties of light received by a user when observing said.

### BACKGROUND OF THE INVENTION

TV sets steadily increase in screen size and, due to the request for high contrast in operation, feature an almost black screen in the off or stand-by state.

As a matter of fact the increasing demand for high daylight contrast of TV screens resulted in the development of many measures for contrast enhancement (phosphor coatings, application of black pigments between the RGB pixels, glass coloration, etc.). The overall effect of these contrast enhancement measures is the reduction of the albedo of the TV screen. Nowadays, this has been driven to such an extent, that TV screens are almost completely black. In other words, a large and flat TV screen in the off or stand-by state appears as a “black stain” at the wall, which might have a negative impact to the cozy atmosphere of living rooms.

Commonly, walls onto which the TV set is installed are white or painted with a light color. This results in an unpleasant contrast to the dark screen that is hanging on the wall whenever the TV set is switched off. Some TV sets having backlight capabilities offer the option to switch on the backlight during the TV off state to obtain a cozy atmosphere, but the TV screen itself remains black.

Hence, an improved system would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above-mentioned problems by providing a system according to the appended patent claims.

An idea of the present invention is to provide a device for placement in front of a display device, such as a TV screen, to change the optical properties of light received by a user observing said display device, when the display device is in an off state or standby state, while when the display device is in an on state, the device appears transparent.

According to an aspect, a system is provided. The system comprises a display device being configured to operate in an on state, off state or stand-by state. The system further comprises a device provided in front of and connected to the display device, said device at least partly allowing light emitted from said display device to pass through said device. Moreover, the system comprises an electromagnetic radiation source emitting electromagnetic radiation onto a surface of the device based on an operation state of said display device.

According to another aspect a display device is provided. The display device comprises a Liquid Crystal Display device configured to operate in an on state, off state or stand-by state. The display device further comprises a control unit, connected to the Liquid Crystal Display device, configured to control the operation of the backlight sources of said Liquid Crystal Display device based on the operation state of the display device. The control unit is further configured to control the transparency of the cells of said Liquid Crystal Display, such that the cells are set to translucent during the off state or standby state of said Liquid Crystal Display device.

An advantage of the system according to some embodiments is that when the display device is set to its off state or standby state, the visual appearance of the display device screen may be changed using the device. For example, the device may provide for a light effect when the display device is in its off state or standby state.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a block scheme of a system according to an embodiment; and

FIGS. 2 to 7 illustrates different embodiments of the system, respectively; and

FIG. 8 is a block scheme of a display device according to an embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The invention described herein is related to the improvement of the design of display device screens during the off or stand-by state. The display device may e.g. by a TV screen, or any other display such as computer monitors.

An idea of the present invention is to provide a device 12 for placement in front of a display device 11, such as a TV screen, to change the optical properties of light received by a user observing said display device, when the display device is in an off state or standby state, while when the display device is in an on state, the device appears transparent.

The following description focuses on embodiments of the present invention applicable to a display system and in particular to a system comprising a display device and a device, whose optical appearance is changeable.

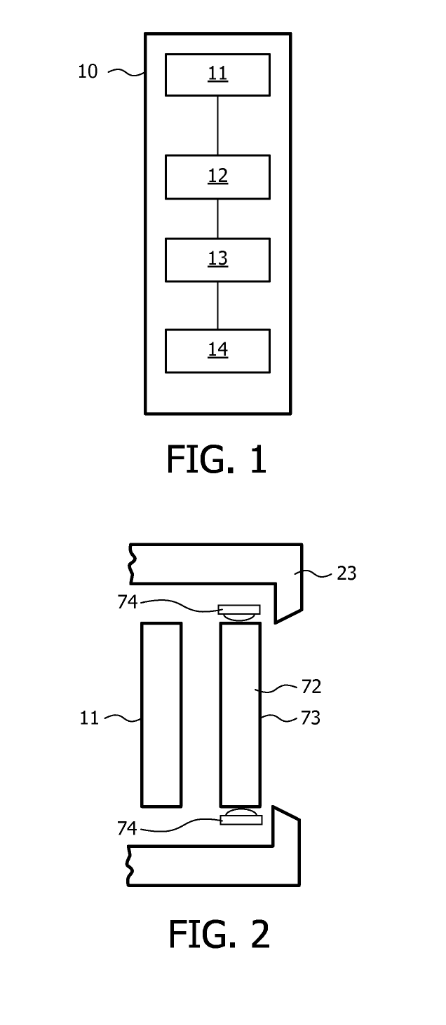

In an embodiment, according to FIG. 1, a system 10 is provided. The system comprises a display device 11 configured to display image content on a screen thereof. The display device may be operated in an on state, off state or stand-by state. The system further comprises a device 12 provided in front of and connected to the display device. The device acts as a light guide for light originating from the display device. The system further comprises an electromagnetic radiation source 13 emitting electromagnetic radiation onto a surface of the device 12 based on an operation state of said display device.

The electromagnetic radiation source may be a light source for emitting Ultraviolet (UV), Near Infrared (NIR), Infrared (IR) or visible light.

In an embodiment the system further comprises a control unit 14 connected to the display device, configured to control operation of the electromagnetic radiation source based on the operation state of the display device 11.

In an embodiment the display device further may operate in an on state in which image content is displayed on the display device screen, and in an off state or a standby state in which no image content is displayed on the screen.

In an embodiment, the control unit 14 monitors the operation state of the display device, and based on the operation state controls the controls the light source such that it emits light onto the surface of the device. For example, when the display device is operating in its off state or standby state the control unit may control the light source to start emit light.

In an embodiment the display device is configured to directly signal to the control unit when entering the off state or standby state.

In an embodiment an optical detector is utilized to detect display device activity, and send a signal to the control unit when an off state or standby state is detected on the display device.

In an embodiment the light sources may be turned on or off using a remote control connected to the control unit.

In an embodiment, in accordance with FIGS. 2, 3, 4, and 6, the device 12 comprises a front plate 72 being configured to reflect light from at least one light source 13. The light source is configured to emit light onto a surface of the device. The light source(s) may be integrated in a common frame, e.g. of the display device, and enlighten the front plate during the off or stand-by state.

In an embodiment, according to FIG. 2, the front plate surface 73 facing away from the display device is roughened, e.g. by means of sandblasting or printing. Light sources 74, such as LED radiation sources may be mounted at the edges of the front plate 72, while the emitted radiation is coupled into the front plate 72. Due to total reflection the front plate 72 acts as a waveguide for the LED light that gets partially coupled out due to the surface roughness. The front plate surface is roughened such as to couple a fraction of the transversally guided light out. Hence, under display use the LED light sources on the edges are off and hence there is no transversal flux that can get out-coupled.

The front plate surface roughness has consequently an optical effect on the light emitted by the display device as the light traveling through the front plate from the display device will be scattered when incident on the roughened front plate surface, thereby e.g. softening a picture presented on the display device screen.

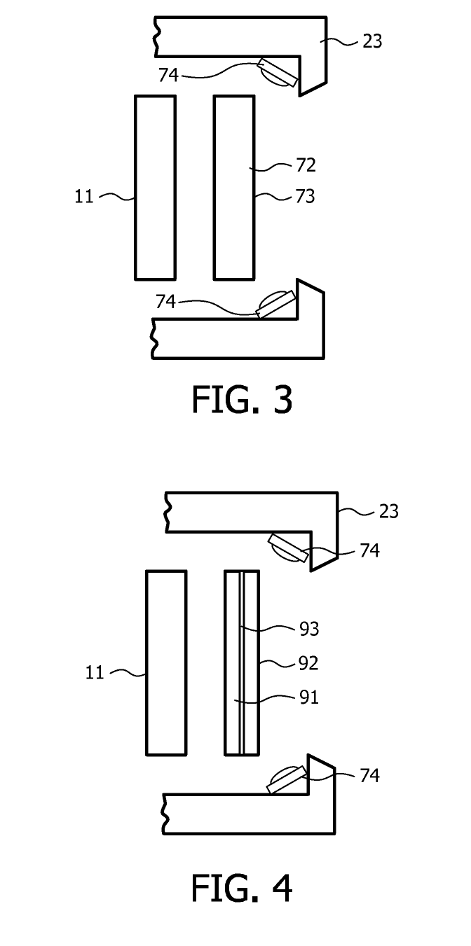

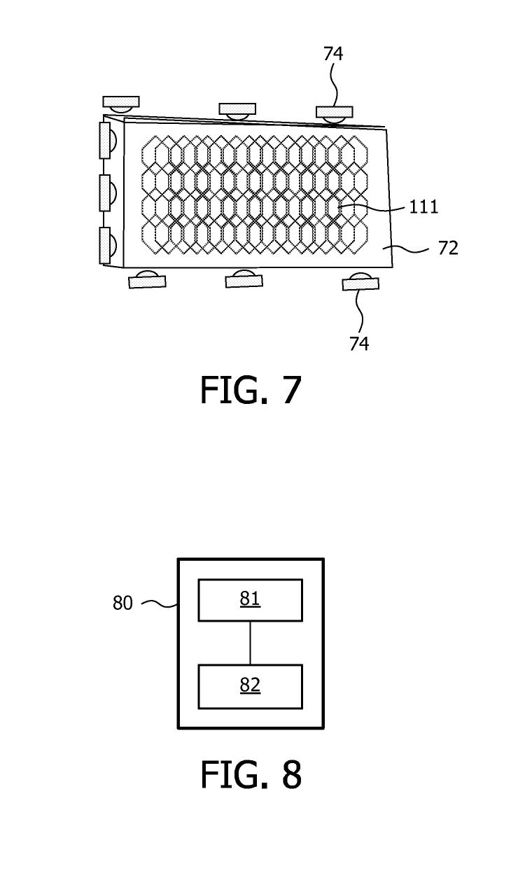

In another embodiment, according to FIG. 3, the light sources 74 are arranged in such a way that they are washing the surface. Shining light on the screen from same side as looking at the reflected light is named washing with light. In FIG. 8 the front plate is also roughened, e.g. by sandblasting, but in this embodiment now light is not originating from inside the front plate 72 but instead shines on the roughened surface 73 from the front and gets diffusely reflected there. In this way no light is coupled out from the front plate, as in the case of the embodiment illustrated in accordance with FIG. 7. As the light sources do not need to be in front of the screen the shallowness of the device will be improved. Also dirt may not reduce the function of the light sources.

It is not essential that the light sources 74 are located in front of the front plate. By utilizing wave guide or mirrors directing light emitted by the light sources 74 onto the front plate, the placement of the light sources 74 may be positioned anywhere in the display device configuration.

In an embodiment, according to FIG. 4, the device 12 comprises a Liquid Crystal Display (LCD) foil 93, optionally sandwiched between two glass plates 91, 92. The light sources 74 are arranged in such a way that they wash the surface of a LCD foil 93 which scatters the light in the off-state of the device 12, rendering a milky white appearance when no electric field is applied to the LCD foil. In the on-state of the device 12 the liquid crystal molecules become ordered by the applied electric filed and LCD foil becomes transparent. Currently transparencies up to 77% are achievable. The transparent LCD foil 91 does not deteriorate the display device picture quality. The LCD foil 91 can be glued directly onto the display device screen or sandwiched between two thin glass.

An advantage of this embodiment is that the appearance of the scattering screen containing an LCD is milky in the off-state, thus when no voltage is applied to the LCD scattering screen. Therefore, it scatters all light present in the room and does not necessarily require illumination by additional light sources. This environmentally desirable feature allows having a milky appearance even if the power of the display device is completely switched off.

In an embodiment, the device 12 comprises at least one luminescent up-conversion material. The luminescent up-conversion material provides for a decorative visible pattern during off state and that do not show up during operation.

An up-conversion material is a material capable of converting low energy light to higher energy emission. For example, when irradiating an up-conversion material with NIR/IR radiation, the up-conversion material may emit visible light.

In an embodiment the luminescent up-conversion material may be excited by means of near infrared radiation, e.g. for example generated by an IR LED. IR LEDs are cheap and highly efficient radiation sources.

The luminescent up conversion material may e.g. be comprised in the group of phosphors, semiconductor materials, or organic materials.

The process of absorbing photons of a certain energy E₁ and emitting photons with another energy E₂, such that E₂>E₁ is called up-conversion.

Photoexcitation at a certain wavelength in the NIR followed by luminescence at a shorter wavelength in the VIS is called NIR to VIS photon up-conversion. The phenomenon of up-conversion is most commonly and best studied in materials containing lanthanide ions. But there are also transition-metal systems and rare-earth/transition-metal combinations as well as organic materials which show this phenomenon.

The use of luminescent up-conversion phosphor materials provides for a number of advantages. For example, excitation may take place in the NIR/IR spectral region. The up-conversion phosphor material is not visible when no IR/NIR radiation is utilized. Hence, by exciting the up-conversion material with NIR/IR radiation, when the display device is set in its off state or standby state, a decorative emission from the up-conversion material in the visible spectral region may be obtained. Moreover, since the up-conversion material does not emit any visible light while not being radiated by NIR/IR radiation, the up-conversion material does not interfere with the backlight from the display device, when the display device is in its on state.

Moreover, different colors are possible under same excitation. Up-conversion phosphor materials may be selected to produce different spectral emission. Hence, by utilizing a number of up-conversion materials, i.e. one material for each color, a multi colored emission of visible light, forming a picture, may be obtained when exciting the up-conversion material using NIR/IR radiation.

Up-conversion materials provides for high photo stability, which means that up-conversion material does not show significant bleaching over operation time. The high photostability of materials is caused by the applied activators, i.e. dopant materials such as Nd3+, which are stable against oxidation or reduction, as e.g. Nd3+.

The up-conversion material comprises a number of small particles, such as particles in the nano scale. The small size of the particles is important to enable a conversion layer that does not scatter the display picture too much. This is valid for up-conversion (IR/NIR) as well as for down conversion (UV) luminescent materials.

In an embodiment, the excitation source may be any kind of NIR emitter. For good coupling to the waveguide, e.g. comprising Poly(methyl methacrylate) (PMMA), and carrying the pumping excitation light, IR inorganic LEDs or IR laser diodes have advantages due to their low price and high beam quality. IR Lasers and IR LEDs allow for quite simple optical coupling into the waveguiding material. The IR radiation may be distributed by means of a waveguide or LEDs may be configured to directly shine on the up-conversion material, such as to wash the up-conversion material with the IR radiation.

In an embodiment, the luminescent material yield a transparent and colorless layer to avoid any scattering or any color filter effect during on-state of the display device.

Applicable inorganic luminescent materials should comprise colorless and nano-scale particles, e.g. having a diameter of less than 50 nm, to avoid scattering or absorption of RGB light emitted from the display device. Suitable materials, which may be excited by NIR/IR radiation are e.g. compositions from the following table 1.

TABLE 1
chemical composition, e.g.

NaYF4: Yb, Er
NaYF4: Yb, Tm
YF3: Yb, Tm
YF3: Yb, Er
NaYF4: Yb, Er
BaY2F8: Yb, Er
YOCl: Yb, Er
Y2O3: Yb, Er
Y2O2S: Yb, Er

In an embodiment, the device 12 comprises a luminescent material.

In an embodiment the luminescent material is a down conversion material. A down-conversion material is a material capable of converting higher energy radiation to lower energy emission. For example, when irradiating a down-conversion material with UV radiation, the down-conversion material may emit visible light.

The luminescent material may be provided in the form of a layer of pattern.

The luminescent material may be used with various display devices, such as CRTs, PDPs, LCDs, EL displays, OLED displays.

The decorative layer may be attached to the display device e.g. by a screen printing, electrophoretic deposition, spin coating or any other suitable process applicable to the glass surface of flat display devices, such as TV screens.

Since the luminescent material should be transparent e.g. when the display device 11 is in its on state, a requirement of the luminescent material is that it is colorless, thereby not interfering with the light emitted by the display device, in use.

In an embodiment, the luminescent material is illuminated with an excitation light source 742, such as a near UV or near IR light source, controlled by the control unit 13, during the off state or standby state of the display device. When illuminated the luminescent material in turn emits visible light to obtain a homogeneous glow or a picture. For example, by printing an up-conversion material in a pattern, e.g. a chess board, the glow is patterned. This is also possible for down conversion materials, enabling the same visual effect. If a conversion material with different emission wavelength is printed together even multicolor effects may be obtained.

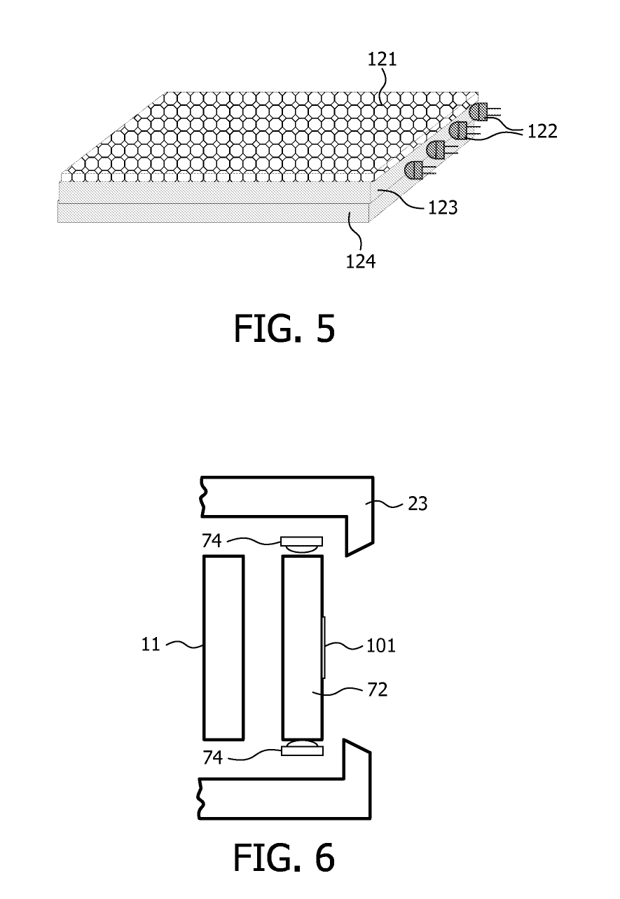

FIG. 5 illustrates the device 12 according to an embodiment comprising a luminescent phosphor material 121, which is activated by an array of UV LEDs 122, and by a transparent waveguide 123 provided onto a glass plate 124 of a display device 11.

In an embodiment the transparent waveguide is part of the display device 11.

In an embodiment the transparent waveguide is part of the device 12. This embodiment may allow for easier manufacture processing.

As excitation light sources 742 either inorganic or organic LEDs or linear fluorescent tubes, e.g. driven by a Hg, Xe, or a Xe/Ne discharge, may be utilized. The emission spectra of these radiation sources should be restricted to the near UV range (350-400 nm), where the human eye sensitivity is nil or can be neglected. Electromagnetic radiation in these wavelength ranges may be distributed by waveguides made out of standard soda lime glass or out of PMMA. An additional light outcoupling structure or foil applied to the waveguide eventually amplifies light outcoupling towards the transparent luminescent material 121.

In an embodiment it is advantageous that the luminescent material is transparent and colorless to avoid any scattering, i.e. reduction of the resolution, or any color filter effect, e.g. shift of the white color point (Tc˜6500 K), since such a luminescent material will interfere as little as possible with the light emitted by the display device. For example, the luminescent layer may be composed of a material, which is inorganic or organic in nature.

A suitable organic luminescent material is, for instance Lumogen F blue, which emits at 440 nm and shows an absorption edge at about 400 nm. As green and red emitters, Ir³⁺-, Tb³⁺-, and Eu³⁺-complexes can be applied.

Applicable inorganic luminescent materials must be colorless and nanoscale powders (d₅₀<50 nm) to avoid scattering of the RGB light emitted by the display device. Suitable phosphors, which can be excited by near UV radiation, are e.g. compositions from the following table.

TABLE 2

| Color | Chemical composition | Peak emission at [nm] |
|---|---|---|
| Red | (Y_{1-x-y}GdₓLu_{y})₂O₂S:Eu | 626 |
| | (Y_{1-x-y}GdₓLu_{y})(V₁₋ₐNbₐ)O₄:Eu | 620 |
| | LiEu(Mo₁₋ₓWₓ)₂O₈ | 616 |
| | La₂(Mo₁₋ₓWₓ)₃O₁₂:Eu | 615 |
| | Sr₂P₂O₇:Eu, Mn | 580 |
| Green | Tb₂(Mo₁₋ₓWₓ)₃O₁₂ | 544 |
| | LiTb(Mo₁₋ₓWₓ)₂O₈ | 544 |
| | (Y_{1-x-y}GdₓLu_{y})BO₃:Ce, Tb | 544 |
| | Zn₂SiO₄:Mn | 525 |
| | BaMgAl₁₀O₁₇:Eu, Mn | 515 |
| Blue | Sr₄Al₁₄O₂₅:Eu | 490 |
| | BaMgAl₁₀O₁₇:Eu | 453 |
| | Sr₃(PO₄)₅(F₁₋ₓClₓ):Eu | 450 |
| | (Ba, Sr)3MgSi2O8:Eu | 450 |
| | (Y_{1-x-y}GdₓLu_{y})₂SiO₅:Ce | 420 |
| | (Y_{1-x-y}GdₓLu_{y})BO₃:Ce | 415 |

In an embodiment of the system, according to FIG. 6, a luminescent material 101 provided, e.g. using screen printing, directly onto the front plate 72. Light sources, such as LED radiation sources, are mounted at the edges of the front plate 72, while the emitted radiation is coupled into the front plate. Due to total internal reflection the front plate 72 acts as a lightguide for the excitation light converted into visible spectrum, whereby light out-coupling occurs at the spots or areas, where the luminescent material is deposited, and thus towards the user.

The front plate may be part of the display device 11 or constitute a part of the device 13. A front plate being part of the device 13 may potentially be less expensive to produce and is likely to reduce the manufacture processing risks should it be incorporated in the display device.

In an embodiment, according to FIG. 7, the front plate 72 is patterned 111 allowing for enhanced out coupling of light from the area of the front plate provided with the pattern. Printed light guiding plates are known in the art for LCD backlights. A printed pattern homogenizes the out-coupled light so that an equal amount of light is provided over the entire screen, such that the screen is not brighter near the frame, at which the light sources may be adjacently located. FIG. 7 is a front view of the system wherein the front plate 72 is provided with a pattern 111, and wherein a number of light sources are provided at the edges of the front plate. In this way an efficient light in-coupling into the light guide plate is obtained.

In another embodiment, the luminescent material 101 is provided directly onto the display device screen 11, and thus it may be an integral part of the display device.

In another embodiment, the luminescent material 101 is mounted inside a common frame that allows it to become fixated to an arbitrary display device. The common frame may also be provided with the light sources 74.

In another embodiment, the pattern 111 is deposited onto an adhesive film (not shown) that may be exchanged by the end customer. In this way the user may change the décor, whenever desired. To this end, the light sources 74, and the front plate 72 may be an integral part of the display device or may be attached as an optional device to e.g. flat TV sets.

In an embodiment, according to FIG. 8, a display device 80 is provided. The display device 80 comprises a LCD device 81, configured to display image content on a screen thereof. The LCD device may be operated in an on state, off state or stand-by state. In an embodiment the backlight sources of said LCD device is turned on in the off state or standby state of the device.

In an embodiment the system further comprises a control unit 82 connected to the LCD device, configured to control operation of the backlight sources based on the operation state of the display device 80.

A LCD device, acting as a display device, is a switchable optical port and needs light sources on the backside of the LCD screen, emitting light through the LCD screen, thereby forming an image on the LCD screen. It is a free choice during manufacturing whether the LCD pixels, i.e. LCD cells, are dark or clear during the off state or standby state.

In an embodiment the control unit 82 is configured to control the transmission of light through the LCD cells of the LCD device, by switching the LCD cells between clear or dark.

In an embodiment, the LCD device is configured to have clear pixels when operating in the off state or standby state. Since the LCD cells are clear during off state or standby state, they act as a window for the backlight, which backlight may propagate towards the viewer's eye. The backlight normally needs to be very bright during display operation in the on state of the display device. In an embodiment, the control unit controls the backlight of the LCD device, to have a lower intensity during the off state or standby state of the display device, than the intensity during the on state, thereby not producing glare.

In an embodiment, when the display device comprises ambient light sources providing ambient light around the LCD display screen, these ambient light sources are used as light sources for the LCD screen during its off state or standby state.

In this case the control unit is configured to control the emission of light from the ambient light sources during the off state or standby state of the LCD device. The emitted light from the ambient light sources may be directed towards a surface, such as the roughened surface, of the device or the switchable LCD device screen. This may be performed utilizing light guides or mirror arrangements. Switchable mirrors or LCD valves may be used to keep the light from the front screen during TV operation.

In an embodiment, the LCD cells, in contrast to common LCD displays, are set to be clear or transparent during the off state or standby state of the LCD device. In this way the backlight may be observed even when the LCD display electronics and the LCD device are without energy. An advantageous effect is obtained if the backlight is dimmed to a flux level that is not producing too much glare. With RGB backlight made with LEDs this is possible.

In an embodiment, the display device 80 comprises a non-colored LCD screen. The LCD screen comprises a number of Red Green Blue (RGB) LED light sources. The color emitted from the non-colored LCD screen results from cyclic or sequential energizing the R the G or the B-LEDs. Accordingly, it is possible to present a viewer with three colors sequentially, without using colored pixels.

The LCD screen is switchable, meaning that is may be set transparent in an off state, and set to drive the light sources of the LCD screen at a low intensity thus creating a light effect from the LCD screen of the unused display device. In this embodiment the LCD screen serves as a large area light source, which is dependent on the backlight sources of the LCD screen. This may in addition support local highlighting and hence give a huge freedom to control light flux and color pattern presented on the LCD screen.

With a non-colored LCD screen the light emitted by the RGB LED light sources are not filtered by means of additional color filters and hence a big fraction of emitted light leaves the LCD screen when the LCD cells are all switched transparent.

In a standby state all cells of the LCD screen are statically set to transparent and the light sources 74 are switched on at low intensity, corresponding to a low current applied over the light sources, thus creating a large area light source. By means of different intensity settings for the color channels of the light sources 741 different light colors can be adjusted.

In the on state the backlight is controlled in detail from the display electronics. In a simple implementation only the colors are sequentially evoked.

However, in a more advanced implementation the control unit 82 controls the backlight of the LCD device by utilizing local dimming in addition to support contrast of the LCD panel.

Based on the embodiment above, attractive, dynamic and colorful light effects may be realized without sacrificing efficacy.

It should be appreciated that even with a conventional LCD screen the display device can give steady light dependent on the setting of transparence in the LCD screen. However if a color filtered LCD screen gets used the overall efficiency is only ⅓ because ⅔ of the light is absorbed by the color filters of the LCD screen.

Using standard backlight that is constantly white over the entire LCD screen only the whole screen gets lit up at a homogeneous color. For TV-sets with local highlight or with scanning backlight the screen may also be illuminated with spatial brightness and/or color variation. Since the spatial brightness may be controlled, this fact may be utilized in the off state or standby state of the LCD screen, thereby providing decorative lightning during the off state or standby states of the display device.

In a further embodiment, the control unit may be configured to control or vary the intensity and/or color over time, e.g. by going from one color to a second color and back at a desired pace.

If the display device comprises external light sources, e.g. for enabling ambient lightning, these too may by utilized and be controlled by the unit rendering a lightning effect originating from both the backlight of the LCD screen and the ambient light sources.

The device 12 according to some embodiments may be used as an integrated decorative front screens of display devices such as TV sets or decorative add-on screens for flat TV sets. Additional applications are displays and billboards.

The control unit may be any unit normally used for performing the involved tasks, e.g. a hardware, such as a processor with a memory.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Any combination of the above mentioned embodiments should be appreciated as being within the scope of the invention. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A system comprising
a display device being configured to operate in an on state, off state or stand-by state, a device provided in front of and connected to the display device, said device at least partly allowing light emitted from said display device to pass through said device, and
an electromagnetic radiation source emitting electromagnetic radiation onto a surface of the device based on an operation state of said display device,
wherein said device comprises:
a Liquid Crystal Display foil, and
an up-conversion material, or a down-conversion material.

2. The system according to claim 1, further comprising a control unit connected to the display device, configured to control operation of the electromagnetic radiation source based on the operation state of the display device.

3. The system according to claim 1, wherein said device comprises a roughened surface, facing away from said display device, enabling out-coupling of electromagnetic radiation emitted from said electromagnetic radiation source.

4. The system according to claim 1, wherein said electromagnetic radiation source comprises a Light Emitting Diode, an Ultraviolet light source, Infrared light source, Near Infrared light source, or an infrared laser.

5. The system according to claim 1, wherein said electromagnetic radiation source is positioned such as to wash said surface of the device with electromagnetic radiation.

6. The system according to claim 1, wherein the Liquid Crystal Display foil is interposed between two glass plates.

7. The system according to claim 1, wherein the up-conversion material or down-conversion material is comprised in the group of: phosphors, semiconductor materials, or organic materials.

8. The system according to claim 1, wherein the up-conversion material or down-conversion material is printed or patterned.

9. The system according to claim 1, wherein said device comprises at least two conversion materials with different emission wavelength, printed together.

10. The system according to claim 1, wherein the up-conversion material comprises particles having a diameter less than 50 nm.

11. The system according to claim 1, wherein the device is attached to the display device by means of screen printing, electrophoretic deposition, spin coating, plate coating, vapor deposition, sputtering, or laser ablation.

12. The system according to claim 1, wherein display device is a Liquid Crystal Display, and the control unit is configured to control the transparency of the Liquid Crystal Display cells based on the operation state of the Liquid Crystal Display.

13. The system according to claim 12, wherein the control unit is further configured to control emission of light from the backlight sources of the Liquid Crystal Display when operating in the off state or standby state.

14. A display device comprising
a Liquid Crystal Display device configured to operate in an on state, off state or stand-by state, and
a control unit, connected to the Liquid Crystal Display device, configured to control:
operation of the backlight sources of said Liquid Crystal Display device based on the operation state of the display device; and
the transparency of the cells of said Liquid Crystal Display, such that the cells are set to translucent during the off state or standby state of said Liquid Crystal Display device.

15. The display device according to claim 14, wherein the control unit is configured to turn on said backlight sources when said Liquid Crystal Display device is in its off state or standby state.

16. The display device according to claim 14, wherein the control unit is configured to control each backlight source utilizing local dimming or scanning.

17. The display device according to claim 14, wherein the control unit is configured to control the intensity and color of each backlight sources.

18. The system according to claim 1, wherein said device comprises:
a Liquid Crystal Display foil and an up-conversion material, and wherein the radiation emitted by said electromagnetic light source is near-infrared or infrared light.

19. The system according to claim 1, wherein said device comprises:
a Liquid Crystal Display foil and a down-conversion material, wherein the radiation emitted by said electromagnetic light source is ultraviolet light.
